(19) United States
(12) Patent Application Publication
(10) Pub. No.: US 2006/0152078 A1
(43) Pub. Date: Jul. 13, 2006

(54) Brake system and method for operating a brake system for electrically driven vehicles

(76) Inventor: Dirk Bald, Friedrichshafen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/539,653

(22) PCT Filed: Dec. 16, 2003
(86) PCT No.: PCT/EP03/14288

§ 371 Date: Jun. 14, 2005

(30) Foreign Application Priority Data
Dec. 20, 2002 (DE) 102 59 878.9

(51) Int. Cl. B60T 8/64

(52) U.S. Cl. 303/155; 303/152

(57) ABSTRACT

A brake system for electrically driven motor vehicles is presented which contains at least one electrically actuated service brake (5) and at least one motor brake.

The present invention concerns a brake system for electrically-driven motor vehicles in accordance with the preamble of patent claim 1. Furthermore, the invention concerns a method for operating a brake system for electrically-driven motor vehicles.

According to the state of the art, electrically-driven motor vehicles, especially industrial trucks for large lifting loads and/or great driving speeds, have hydraulically or mechanically actuated service brakes, which can be controlled by the motor vehicle driver or operator. Usually the traction motor is used in addition for braking, whereby this takes place as a function of the brake pedal position.

First, the use of hydraulic braking systems requires an additional pressure medium or brake fluid in the electrically-driven motor vehicle. Moreover, the pressure medium must be changed regularly due to its hygroscopic property. In addition, braking systems of this type must be bled during installation and during servicing.

Second, the construction of simple, exclusively mechanical brake systems is not possible in each vehicle, for example, due to the necessary control cable lengths, the number of deflections, etc. Hydraulic as well as mechanical systems have a fixed characteristic curve between pedal force and/or pedal path and braking force so that it proves to be difficult to incorporate the braking action of the motor into these in order to create clear conditions for the driver.

According to the state of the art, the drive motors of industrial trucks are used in four quadrant operation for braking. DE 196 48 979 A1 describes a drive axle with two tractions motors in which the first traction motor is connected with a first drive shaft; the second traction motor is connected with a second drive shaft for driving one wheel in each case, whereby a brake is arranged axially between the traction motors, which has at least one brake rotor which is axially displaceable on the first output shaft; at least one brake rotor which is axially displaceable on the second output shaft, and the brake rotors can be brought into operative connection with a brake rotor using at least one braking actuating facility generating an axial force.

A method for operating an electro-magnetically released spring applied brake is described within the framework of EP 0 735 292 B1.

The present invention is based upon the objective of indicating a brake system for an electrically-driven motor vehicle, especially an industrial truck, which can be implemented without additional media, such as brake fluid. The brake system should be unambiguously meterable for the driver and create an optimal interaction between the braking action of the motor vehicles and the service brakes under all driving conditions. Furthermore, a method for operating the brake system is to be indicated.

This objective is accomplished by the features of patent claim 1. A method for operating the brake system is the object of patent claim 9. Further refinements and advantages become apparent from the dependent claims.

Accordingly a brake system is proposed which contains at least one electrically actuated service brake, as a service brake whose control unit can be directly incorporated into the motor vehicle control unit or into the motor control unit. In addition to the service brake, the motor brake is also used.

In this connection, the most effective combination of electric motor brakes and service brakes is ascertained in accordance with the invention by a brake management unit or by the brake control unit, depending upon the driving state. AC motors contain a position/rotational speed sensor whose information, according to the invention, is also forwarded to the brake management unit or to the brake control unit. Subsequently, the braking force of the service brake can take place as a function of the braking action of the traction motor or traction motors and the specification of the driver (through actuation of the brake pedal or brake lever).

In this way, gentle braking as well as gentle and finely metered driving on inclines, ramps or the like is made possible. In accordance with the invention, the characteristic curve between pedal force or pedal path and braking force is influenced in the control unit, as needed.

The invention is explained in greater detail below on the basis of the appended figures, wherein:

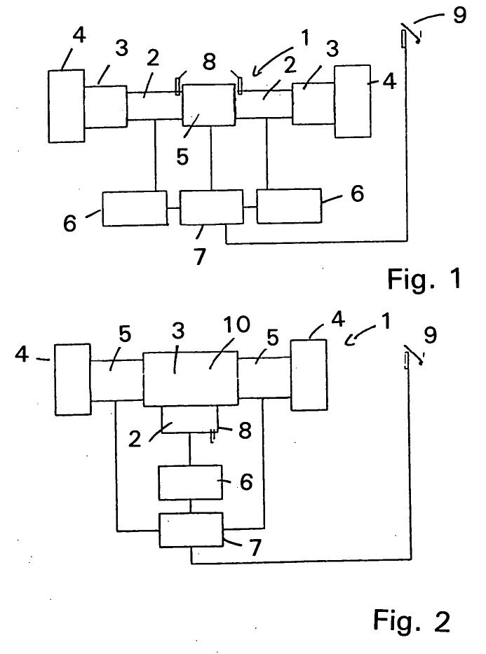

FIG. 1 is a schematic representation of the brake system for a driving axle with two electric motors in according with the present invention; and

FIG. 2 is a schematic representation of the brake system for a drive shaft with one electric motor in accordance with the present invention.

A drive axle 1 of an electrically driven motor vehicle is represented in FIG. 1 which has two electric motors 2 which, in each case, drive a wheel 4 via a transmission 3. In accordance with the invention, an electrically actuated brake 5 is provided as a service brake, which is arranged between the two electric motors 2 within the framework of the embodiment shown in the Figure. The control unit of the electrically actuated brake 5 is directly incorporated preferably into the motor vehicle control unit or into the motor control unit 6 of the electric motors. In addition to the service brakes, motor brakes are also used, in accordance with the method of the invention, for operating the brake system. The most effective combination of electric motor brakes and service brakes is ascertained from the electrically actuated brake 5 and the motor brake by the brake management unit or a brake control unit 7 as a function of the driving state. Here a motor control unit 6 and the brake control unit 7 can be incorporated into a facility or, as shown in the Figure, is arranged spatially separated, in this case, the connection preferably takes place through a bus system.

Position/rotational speed sensors 8 can be used for this purpose which are, in any case, provided with AC motors whose information is also forwarded, in accordance with the invention, to the braking management unit or the braking control unit 7 for evaluation of the braking action of the electric motors 2.

Subsequently, the electrically actuated service brake 5 is controlled as a function of the braking action of the traction motor or traction motors 2 ascertained by the brake control unit 7 and the specification on the part of the driver input by activation of the brake pedal 9 or a brake lever.

According to the present invention, a schematic representation of the brake system for the drive axle 1 with one electric motor 2 is shown in FIG. 2. In this connection, a drive output of the electric motor 2 is transmitted to the wheels 4 via the transmission 3 and a differential 10. The electrically actuated brake 5 is provided as a service brake in each case, in accordance with the invention, between the differential 9 and each wheel 4. Here too the signals of the position/rotational speed sensor 8 of the electric motor 2 are used and passed on to the brake management unit or to the brake control unit 7 for evaluation of the braking action of the electric motor 2.

The brake system presented here can exist without current in the braked or non-braked state. Moreover, the braking force can be maintained at a constant level in case of a drop in electric energy. Within the framework of an advantageous variant of the method for operating the brake system, the braking force can assume a certain value in a time-controlled or event-controlled manner in the event of a drop in electric energy.

A further embodiment of the present invention provides that, if necessary, a mechanical or a hydraulic emergency brake or emergency actuation system is incorporated into the brake system as an underlying unit.

The service brake 5 can additionally also operate as a parking brake. Actuators can be used as brake actuators for the electrically actuated brake 5, operating electromagnetically or even piezoelectrically through an electric motor, according to the invention.

### REFERENCE NUMERALS

1 drive axle
2 electric motor
3 transmission
4 wheel
5 electrically actuated brake
6 motor control unit
7 brake control unit
8 position/rotational speed sensor
9 brake pedal
10 differential

1-12. (canceled)

13. A brake system for an electrically driven motor vehicle with at least one electrically actuated service brake (5) and at least one motor brake of an electric motor (2), the electrically actuated service brake (5) being controlled as a function of braking action of the motor brake and a specification of a driver, and the braking action of the motor brake is evaluated on a basis of information from a position/rotational speed sensor (8) of the motor brake.

14. The brake system according to claim 13, wherein a control unit (7) of the electrically actuated service brake (5) is directly incorporated into one of a motor vehicle control unit or a motor control unit (6).

15. The brake system according to claim 13, wherein a control unit (7) of the electrically actuated service brake (5) is directly incorporated into a motor control unit (6), and the motor control unit (6) and the brake control unit (7) are spatially integrated into one apparatus.

16. The brake system according to claim 13, wherein a control unit (7) of the electrically actuated service brake (5) is directly incorporated into a motor control unit (6), and the motor control unit (6) and the brake control unit (7) are connected with each other through a bus system.

17. The brake system according to claim 13, wherein a characteristic curve between one of a pedal force or a pedal path and a braking force can be influenced in the control unit (7).

18. The brake system according to claim 13, wherein one of a mechanical braking system, a hydraulic emergency braking system or an emergency actuation system is incorporated into the braking system as an underlying unit.

19. The brake system according to claim 13, wherein the electrically actuated service brake (5) additionally functions as a parking brake.

20. The brake system according to claim 13, wherein actuators actuating electromagnetically, through one of an electric motor and piezo-electrically devices, can be used as braking actuators for the electrically actuated service brake (5).

21. The brake system according to claim 13, wherein the position/ rotational speed sensor (8) is used for each electric motor (2) whose information is forwarded to one or a brake management unit or the brake control unit (7) for evaluation of the braking action, and the electrically actuated service brake (5) is controlled as a function of the braking action of the electric motor (2) or the electric motors ascertained by the brake control unit (7) and a specification on the part of the driver input through an activation of a brake pedal (9) or a brake lever.

22. The brake system according to claim 13, wherein a braking force assumes, time-controlled or event-controlled, a specified value in an event of a drop in electric energy.

23. The brake system according to claim 13, wherein the parking brake engages without current is bled with current while the service brake acts in one of a same manner or is also bled without current and engages with current.
